(19) United States
(12) Patent Application Publication
(10) Pub. No.: US 2020/0151246 A1
(43) Pub. Date: May 14, 2020

(54) Labeling Training Set Data

(71) Applicant: International Business Machines Corporation, Armonk, NY (US)

(72) Inventor: Chris Mwarabu, Holly Springs, NC (US)

(21) Appl. No.: 16/189,397

(22) Filed: Nov. 13, 2018

(51) Int. Cl. G06F 17/27; G06F 15/18; G06F 17/30; G06K 9/62

(52) U.S. Cl. CPC G06F 17/277; G06F 15/18; G06K 9/6256; G06F 17/3071; G06F 17/30707

(57) ABSTRACT

A computer readable storage medium comprising instruction which when executed cause a processor to: generate a machine learning model based on a limited set of labeled training data and a larger set of unlabeled training data, the labeled and unlabeled training data having a common subject matter, by: identifying an inclusion and exclusion list of terms; taking a subset of unlabeled documents which contain any term from the inclusion list and excluding any document that contain a term from the exclusion list; identifying terms that are similar within a set standard to a term from the inclusion list or exclusion list and adding those identified terms to the inclusion list or exclusion list, respectively; repeating until no new similar terms are identified; and generating training data of the machine learning model comprising a final subset of documents for each category from the unlabeled training data.

### BACKGROUND

The present invention relates to machine learning (ML) systems. Specifically, the present invention describes an automated method of labeling unlabeled data so as to create training cases for machine learning systems.

Machine Learning (ML) systems may be trained with a training set of cases. The training cases include information and the answer the machine learning system is to produce from that information. The information can take many forms, for example, a text, an image, an anonymized medical record, an audio clip, etc. The accuracy of the machine learning system's performance may depend on the size and quality of the training set. If the accuracy of the answers in the training set is low then the resulting answers produced by the ML system may be of similarly inaccurate. If the quantity of material in the training set is small, the system may not have adequate information to span the range of inputs. This may also reduce the accuracy of the ML system's answers. However, generating a high-quality, large training set is a significant undertaking, often requiring expert time and review of each case. In complex areas, it is not unknown to use a panel of experts to form the determination for the training cases. While this improves the quality of the answer for the cases, it is potentially costly and time consuming. Accordingly, it is desirable to develop a way to economically produce high-quality, large training sets.

### SUMMARY

Among other examples, this specification describes a computer readable storage medium including instruction which when executed cause a processor to: generate a machine learning model based on a limited set of labeled training data and a larger set of unlabeled training data, the labeled and unlabeled training data having a common subject matter. The processor does this by for each of a number of categories, identifying an inclusion list of terms corresponding to training data being classified and an exclusion list of terms corresponding to training data not currently being classified. The processor, for each of the categories, takes a subset of documents from the unlabeled training data, the subset including all documents that contain any term from the inclusion list and excluding any document that contain a term from the exclusion list. The processor, within each subset of documents, identifies terms that are similar within a set standard to a term from the inclusion list or exclusion list and adding those identified terms to the inclusion list or exclusion list, respectively. The processor repeats the taking of a subset of documents from the unlabeled training data based on the inclusion and exclusion lists and the identification of similar terms from within those subsets of documents until no new similar terms are identifies within the set standard. The processor generates training data of the machine learning model comprising a final subset of documents for each category from the unlabeled training data.

In some examples, the set standard comprises cosine similarity of corresponding word or phrase vectors. The processor may further, when generating the inclusion list and exclusion list, extract potential phrases from the unlabeled training data and tokenizing each of the phrases as a single word. The processor may generate word vectors for each document of the subset based on the tokenized phrases. In an exemplary embodiment, the unlabeled data includes medical records and the terms on the inclusion and exclusion list include medical terms.

This specification also describes a computer-implemented method of topic extraction from a corpus of documents having a subset of labeled documents. The method includes identifying, from the labeled documents, a plurality of inclusion lists, wherein each inclusion list comprises a set of terms identifying a shared topic. The method includes determining an exclusion list for each inclusion list, wherein the terms from any inclusion list are present on the exclusion list of all other inclusion lists. The method includes identifying in the corpus, a first document with a term of the set of terms of a first inclusion list and wherein the document contains no term on the exclusion list of the first inclusion list. The method includes tokenizing terms from the set of terms of the first inclusion list in the first document. The method includes parsing the first document to form n-grams and sorting the n-grams to identify potential new terms based on cosine similarity. The method includes comparing a part of speech of the potential new terms against the part of terms of the set of terms. The method includes adding high frequency n-grams to the set of terms of the first inclusion list and adding high frequency n-grams to the exclusion list of inclusion lists other than the first inclusion list. The method includes repeating the operations of identifying, tokenizing, parsing, sorting, comparing, adding, and adding for each of the inclusion lists until no unlabeled document remains in the corpus which has a term on an inclusion list while not having a term from the associated exclusion list.

In an example, a document is a paragraph of a larger document. For example, the documents of the corpus may be abstracts. The exclusion list may be further populated with identified terms from labeled documents in the corpus. The method may also include wherein all documents in the corpus having the identified keyword without a keyword from the associated exclusion list are parsed to form n-grams and wherein the n-grams are sorted together to identify high frequency n-grams. In an example, the n-grams are sorted based on frequency over baseline, wherein the baseline is determined from a second corpus of documents without terms from any exclusion list. The method may further include identifying a high frequency n-gram associated with a new topic and creating a new topic including the high frequency n-gram on the inclusion list. In some examples, the method also includes extracting topics from a database.

This specification also describes a system for reviewing medical diagnoses. The system includes a corpus of medical records stored in a computer readable non-transitory format, and processor having an associated memory. The associated memory contains instructions, which, when executed, cause the processor to identify a set of medical conditions, wherein each medical condition has at least one term for the medical condition. The processor identifies additional terms for the medical conditions of the set of medical conditions from a data base. The processor creates an exclusion list for each medical condition, wherein the exclusion list comprises every other medical condition in the set of medical conditions. The processor identifies a medical record in the corpus of documents containing a term from the inclusion list for a first medical condition and not containing any terms from the exclusion list for the first medical condition. The processor parses the identified medical record to form n-grams. The processor filters the n-grams to identify n-grams with a same part of speech as a term for the medical condition. The processor identifies filtered n-grams within a threshold separation based on cosine distance between the terms for the first medical condition and a filtered n-gram. The processor adds the identified filtered n-grams to the list of terms for the first medical condition.

In an example, the instructions further cause the processor to redact the corpus of documents.

### BRIEF DESCRIPTION OF THE DRAWINGS

The accompanying drawings illustrate various examples of the principles described herein and are a part of the specification. The illustrated examples do not limit the scope of the claims.

FIG. 1 shows a flowchart of a process of preparing machine learning (ML) training sets according to an example of the principles described herein.

FIG. 2 shows an example of identifying part of speech of an extracted n-gram in a method consistent according to an example of the principles described herein.

FIG. 3 shows a machine readable storage medium containing instructions, which when executed, cause a processor to generate a machine learning model based on a limited set of labeled training data and a larger set of unlabeled training data, the labeled and unlabeled training data having a common subject matter according to an example of the principles described herein.

FIG. 4 is a diagram of a computing device for identifying ground truth of unlabeled documents, according to an example of the principles described herein.

FIG. 5 shows a flowchart of a method of topic extraction from a corpus of documents having a subset of labeled documents according to an example of the principles described herein.

FIG. 6 shows a diagram for a system for reviewing medical diagnoses in an example according to an example of the principles described herein.

Throughout the drawings, identical reference numbers designate similar, but not necessarily identical, elements. The figures are not necessarily to scale, and the size of some parts may be exaggerated or minimized to more clearly illustrate the example shown. The drawings provide examples and/or implementations consistent with the description. However, the description is not limited to the examples and/or implementations shown in the drawings.

### DETAILED DESCRIPTION

Often publicly available data is found in forms which are not indexed by the desired properties being sought for the machine learning (ML) system. For example, journal articles, news articles, bldg posts, video footage, etc, may be available with minimal indexing, for example, a keyword or keywords or without any identifiers at all. Medical records, which are needed to develop medical diagnostic systems, may be unavailable, unindexed, and/or redacted. Some scrubbed medical records, often imaging results, are available in public but the size of such data sets is often small. Further such data sets may or may not include diagnosis information. While the best such records contain information on the progress of the patient after the information was acquired, allowing confirmation of the diagnosis, such data sets are very limited. Further, studies of deanonymization have demonstrated the difficulties of truly anonymizing medical data while include enough information to be useful for developing models. Similarly, other records may have limited public availability, redacting, and/or privacy concerns.

The interest in developing machine learning systems able to provide a “second opinion” in medical diagnosis remains an area under development. Because of the cost of misdiagnosis and the cost of obtaining multiple opinions, this area is viewed as one where machine learning systems may provide significant value to patients. Machine learning systems are also being actively investigated in a wide variety of contexts, including voice to text, translation, image analysis, etc.

The present invention may be a system, a method, and/or a computer program product. The computer program product may include a computer readable storage medium(or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating rough a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on. the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used in this specification and the associated claims, the phrase “a number of” is understood to cover one and/or multiple of the identified item. The phrase “a number of” does not cover negative amounts of or zero of the identified item. This is because interpreting the phrase “a number of” to include zero makes the associated phrase non-limiting and undescriptive.

As used in this specification and the associated claims, the phrase “ground truth” is the correct answer from a machine learning system in response to a document or other source of data of a test case. The ground truth is associated with the document or other source of data in a test case used to train a machine learning system. The ground truth may, but need not, appear in the data of the test case.

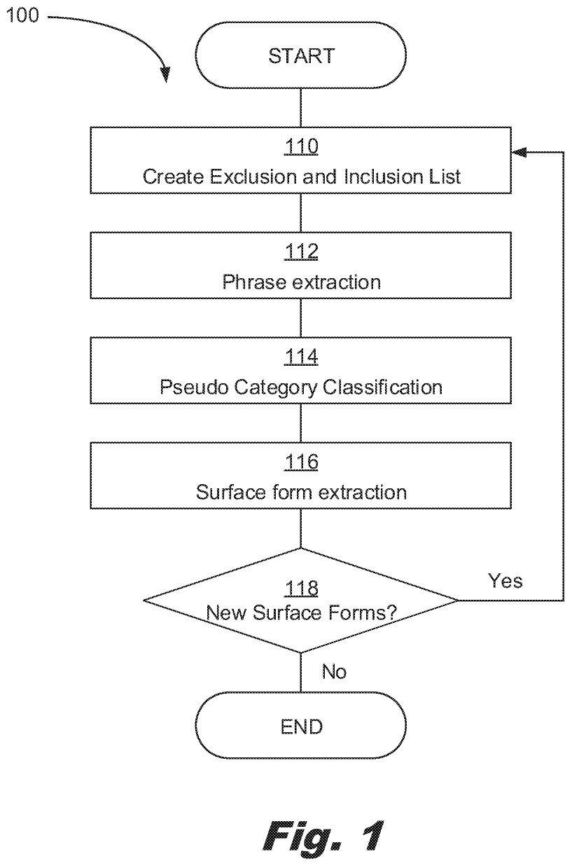

Turning now to the figures, FIG. 1 shows a flowchart of a process (100) of preparing a machine learning (ML) training set consistent with this specification. The process (100) includes: create (110) exclusion and inclusion lists; phrase extraction (112); pseudo category classification (114); and surface firm extraction (116). At this point if there are new surface forms (118) the new surface forms are added to the inclusions and exclusion lists and the process is repeated until there are no new surface forms.

The method (100) is a method of preparing a machine learning (ML) training set from a first, smaller group of labeled data and a second, larger group of unlabeled data. The method uses an iterative process to identify additional terms. The method also sorts the data into those having references to a single term and those with multiple terms. The data with multiple terms are excluded from the training set. For example, if the data was published studies and breast cancer was a first term while lung cancer was the second term, studies that referenced both breast and lung cancer would be excluded from the training set.

The method includes creating (110) the exclusion and inclusion lists. For each category, the inclusion lists contains synonyms for the category. This allows data that references the same information by different terms to be combined. For example, Lung cancer and lung carcinoma are both terms for a single topic. Similarly, more specific terms, e.g., cancer of the left inferior lobe, tumor in the right lung, etc., may also be included. While experts are skilled at understanding different phrasings for material in a common category, machine learning systems require that a category be identified by a single identifier in order to recognize it as part of a term.

In some examples, the terms of the inclusion list are tokenized prior to further analysis of the data. In this approach, all instances of any term in an exclusion list are replaced with a token. The token may be one of the terms on the list. The token maybe a non-word identifier, e.g., *Topic1476*, XX&XX, or another combination. The token may include non-letters such as number and/or special symbols to avoid accidental confounding of the terms in the data with tokens. If the token uses a distinct identifier such as the paired asterisks above, the data may be scanned for possible structures similar to the token prior to processing. If a potentially confounding structure is found, the document may be excluded. The document may be scrubbed of the confounding structure(s). The document may be processed but with a flag of some sort to ignore the similar structure. The tokens may be different for different topics, for example, by indexing and/or incrementing a value. The token may be independent of the topic.

A document can contain multiple references to a topic. These may all be replaced by instances of the token. A document which contains references to multiple topics will be excluded from further processing. This is because each member of an inclusion list is present on exclusion lists of all other topics to avoid data with overlapping topics during training. Accordingly, one does not need to distinguish tokens in a given document.

In some examples, the terms for the inclusion list and exclusion list are extracted from an available database. A variety of fields include databases which include synonym information. For example, many chemical databases list a number of synonyms for chemicals in addition to the current International Union of Pure and Applied Chemist (IUPAC) convention name. These may include common name(s) and other variant names. These types of synonym databases may be especially useful in the nomenclature in the field has shifted over time. Other databases include synonyms of key terms to facilitate search. An example of this is the MESH terms in the PubMed database which includes multiple different terms for different diseases. This variation may be due to shifting use over time, e.g., from Lou Gehrig's disease to Amyotrophic Lateral Sclerosis (ALS) disease. The variation may be due to a common name vs. a more formal medical term, e.g., cancer vs. carcinoma. Terminology may shift due to splitting of topic into multiple topics, either as specialized sub areas or even distinct topics which were not previously recognized as distinct. Regardless, identifying sources that have already identified different synonyms in a given field may facilitate preparing the inclusion and exclusion lists. In some cases, it may be use to limit the publication date(s) when a synonym is included in an inclusion and/or exclusion list. In an example, a term is included for publications prior to a date and excluded for publications after that date. Some modem tools for usage of terms over time may also be useful to recognize changes in terminology and/or the associated time period of use for a term.

The method (100) includes phrase extraction (112). Phrase extraction parse text to look for clusters of words which occur with a high frequency. Such high frequency clusters may indicate additional meaning or significance to the combination. For example, the word “New” often precedes “York” indicating that the idea of “New York” may be distinct from the idea of “York.” Phrase extraction may be performed to generate n-grams. An n-gram is a string of elements (such as letters, words, or phonemes) that appears within a longer sequence. For example the sentence, “the dog is tired” contains two different 3-grams “the dog is” and “dog is tired.”

N-grams are used in natural language processing to predict the next element in the series. N-grams may be used to predict specific elements or categories of elements (e.g., vowel or adjective). For example, the n-gram “My car is” suggest some categories of words (e.g., adjectives, adverbs, verbs) and not other kinds of words (e.g., nouns).
Phrase extraction may prepare n-grams for a document. In some examples, the n-grams include a compensation factor based on size. For example, a 20-gram of 20 words is highly unlikely to occur twice in a document unless it is deliberately reproduced. In contrast, the 2-gram “and the” may occur many times in a document without being particularly significant. In an example, the n-grams are sorted within their individual size clusters to identify the most frequent n-grams of each size. if a bias based on size is included, then all the n-grams from a document or documents may be combined to identify the highest frequency n-grams. A variety of techniques are available for extracting and prioritizing n-grams. Among other references, an example of a useful approach is described in Distributed Representation of Words and Phrases and their Compositionality, Mikolov et al., Advances in Neural Information Processing Systems 26 (NIPS 2013). This approach may be particularly useful when incorporating skip-grams which look for element combinations within a certain distance from each other, for example, by “skipping” or excluding a number of intermediate elements.

In one example, the n-grams are formed into a vector. A vector of n-grams is similarly generated for a control document, for example, the corpus of documents already associated with the terms of the inclusion list. These documents may be compared to assess how similar the new document is to the existing corpus. In an example, the comparison is cosine distance. The comparison may use z-scores (standard scores, normalized scores) and/or g-scores (likelihood test) to assess similarity of the new document and the corpus.

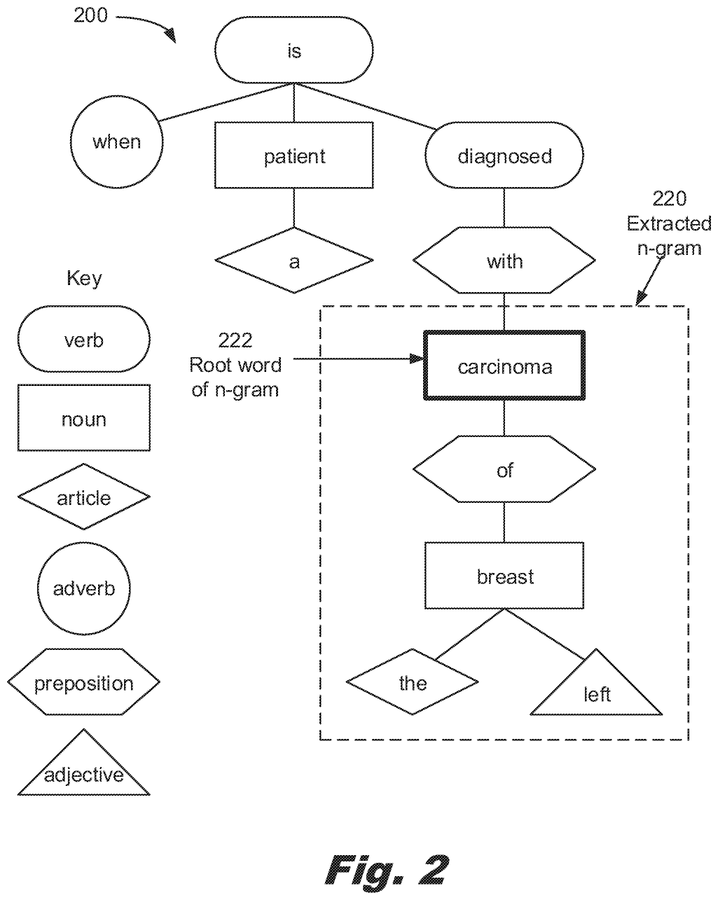

The method (100) includes surface form extraction (116). Once potential synonyms are identified using phrase extraction, additional checks are preformed to reduce false positives. One method to reducing false positives is to verify that the part of speech of the synonym is the same as the original topic. This provides a secondary check to assure the quality of the potential synonyms prior to adding them to the inclusion/exclusion lists. An example of breaking down an identified n-gram synonym is shown in FIG. 2, below. Further discussion of this step is available below.

If the root part of speech of the synonym matches the topic, then the synonym is added to the inclusion list of the topic. The synonym is also added to the exclusion of each other topic. This again preserves the separation between the topics to avoid the use of data reciting multiple topics.

The method (100) includes if there is a new surface form (118) the new surface form(s is added to the inclusion and exclusion lists and the process is repeated until there are no new surface forms. This iterative approach allows the extension of the topic to synonyms beyond those directly associated with the original terms. For example, Term A may be used to identify Term B which is then used to identify Term C, even if no piece of data (or document) available contains both A and C.

Iteration continues until no new synonym(s) are identified. This may be due to all documents having an associated synonym or being excluded for having identifiers for multiple topics present.

In some examples, the method (100) may further include flagging extracted terms as alternate topics. The method (100) may include human review of the synonyms. The method (100) may provide for trimming terms by a human reviewer. Any of these may provide the semi-supervision of the method. In an example, the synonyms are presented in a list with checkboxes or similar to allow a reviewer to exclude them. In an example, the options for the identified synonyms include ignore and set as a new topic.

FIG. 2 shows an example of identifying part of speech of an extracted n-gram in a method consistent with the present specification. Each part of speech is identified with a different type of box. The extracted n-gram (220) is shown in a dashed box in the context of an instance of the use of the extracted n-gram (220) in the data. The root word of the n-gram (222) is shown at the top do the diagramed extracted n-gram (220).

In this example, the topic is breast cancer. The extracted n-gram (220) is “carcinoma of the left breast” This extracted n-gram (220) has been previously identified as occurring with atypical frequency in the steps described with respect to FIG. 1, above. A portion of the text containing the extracted n-gram (220) has been diagramed to determine the parts of speech. The portion may be limited to the extracted n-gram (220). The portion may include text before and/or after the extracted n-gram (220) to aid in determining the parts of speech. The root word of the n-gram (222) is identified and its part of speech determined. In this example, the root word is carcinoma and the part of speech is noun. As this is the same part of speech as the topic “breast cancer” which is also a noun, the extracted n-gram (220) is added to the inclusion list for the topic breast cancer. The extracted n-gram (220) is also added to the exclusion list for each other topic, e.g., prostate cancer.

It has been found that verifying the parts of speech are the same for the topic and the extracted n-gram (220) improves an effective filter against unrelated but high occurring n-grams which might otherwise require manual review, Accordingly, this step provides an improvement to the automation of the described process allowing faster iteration and reduced requirement for human supervision.

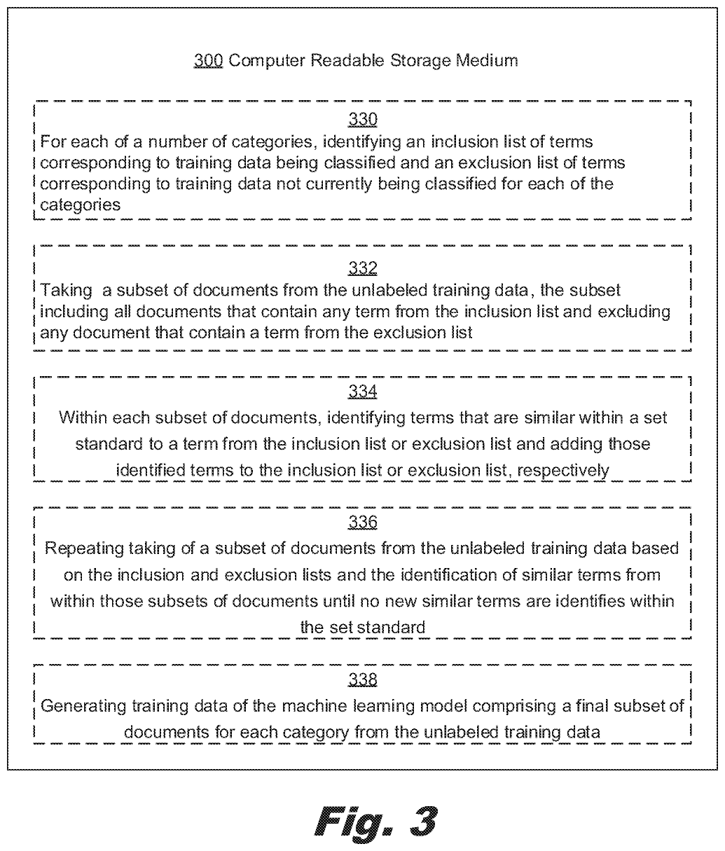

FIG. 3 shows a flowchart for a computer readable storage medium (300) comprising instructions for generating a machine learning model based on a limited set of labeled training data and a larger set of unlabeled training data, the labeled and unlabeled training data having a common subject matter consistent with this specification. The medium (300) includes instructions, which when executed, cause a processor to: for each of a number of categories, identify (330) an inclusion list of terms corresponding to training data being classified and an exclusion list of terms corresponding to training data not currently being classified; for each of the categories, take (332) a subset of documents from the unlabeled training data, the subset including all documents that contain any term from the inclusion list and excluding any document that contain a term from the exclusion list; within each subset of documents, identify (334) terms that are similar within a set standard to a term from the inclusion list or exclusion list and adding those identified terms to the inclusion list or exclusion list, respectively; repeat (336) the taking of a subset of documents from the unlabeled training data based on the inclusion and exclusion lists and the identification of similar terms from within those subsets of documents until no new similar terms are identifies within the set standard; and generate (338) training data of the machine learning model comprising a final subset of documents for each category from the unlabeled training data.

The medium (300) contains instructions for forming a training set for a machine learning model including identifying the ground truth for cases to be included in the training set. The cases are drawn from two pools; the first pool has been labeled with ground truth and a second, larger pool which is unlabeled. Normally, an expert or other reviewer would need to manually review the second pool an assign ground truth to those cases. However, the time and cost for manually assigning ground truth tends to limit the size of training sets. This, in turn, limits the basis of the machine learning system's performance. Accordingly, the medium (300) provides an approach to automate and/or semi-automate the labeling of unlabeled documents in order to economically expand the size of the training set.

The medium (300) includes instructions, which when executed, cause a. processor to for each of a number of categories, identifying (330) an inclusion list of terms corresponding to training data being classified and an exclusion list of terms corresponding to training data not currently being classified. A phrase or identifier being on an inclusion list for a term also results in the phrase or identifier being placed on the exclusion lists for all other terms. Accordingly, each term is viewed as a distinct, non-overlapping category. This is a simplification which is used to anchor each of the categories for the machine learning training set. Documents that reference multiple categories are excluded from the training set because of the difficulty of providing them as non-representative of the associated category.

The medium (300) includes instructions, which when executed, cause a processor to for each of the categories, take (332) a subset of documents from the unlabeled training data, the subset including all documents that contain any term from the inclusion list and excluding any document that contain a term from the exclusion list. As each exclusion list includes the terms of the categories, this process identifies documents which only have terms associated with a single category. This reduces the inclusion of documents which may represent multiple categories.

The medium (300) includes instructions, which when executed, cause a processor to within each subset of documents, identify (334) terms that are similar within a set standard to a term from the inclusion list or exclusion list and adding those identified terms to the inclusion list or exclusion list, respectively. A variety of approaches may be used to identify terms, to determine similarity, and to form the set standard.

When generating the inclusion list and exclusion lists, the medium (300) may include extracting potential phrases from the unlabeled training data and tokenizing each of the phrases as a single word. Tokenization may also be applied to words with a shared root, for example, to reduce the impact of present vs, past tense.

In an example, identifying terms may be performed by forming n-grams and/or skip n-grams. The resulting n-grams may be sorted by frequency, either absolute or relative. In an example, the n-grams are assessed on a document by document basis. The n-grams for the entire subset may be analyzed collectively. Although document may be an entire publication or similar taken collectively, documents may also be portions of a publication. For example, the different sections of a publication may be treated as separate documents. In an example, an abstract is a document in an example, a background section is treated as a separate document from the remainder of a publication.

Forming n-grams may include dropping low information words, such as articles (a, an, the). This may be performed as an intermediate step between n-grams and skip n-grams, where n-grams include all the elements and skip engrams may eliminate order information.

Determining similarity may be performed using cosine between a vector of the term being considered and the other identifier(s) of the category. Other approaches include using z-scores (standard variation) and/or g-scores. In one example, the vector of the n-gram is compared to a control corpus and that comparison is assessed relative to the vector of the category identifier(s) relative to the control corpus.

The similarity determination may use a set standard to assess whether an n-gram should advance to the next step of the process. The similarity determination may use a variable and/or dynamic standard. In an example, the dynamic threshold depends on the size of the document(s) used to generate the distribution of n-grams. A larger set of documents may allow a lower threshold while a smaller set of documents may use a higher threshold to reduce false positives. The set standard may include cosine similarity of corresponding word or phrase vectors. In an example, the medium (300) uses multiple set standards to provide additional checks of likelihood of match. The medium (300) may include generating word vectors for each document of the subset based on the tokenized phrases.

The medium (300) includes instructions, which when executed, cause a processor to repeat (336) the taking of a subset of documents from the unlabeled training data based on the inclusion and exclusion lists and the identification of similar terms from within those subsets of documents until no new similar terms are identifies within the set standard. The use of an iterative approach allows the method to reach related synonyms which are not directly related to the original terms but rather are related through a discovered synonym. This approach potentially provides new documents with ground truth when a synonym is identified for a topic. As long as new synonyms are being identified and added, the amount of defined test cases in the form of documents with ground truth continues to increase. The medium (300) includes instructions, which when executed, cause a processor to generate (338) training data of the machine learning model comprising a final subset of documents for each category from the originally unlabeled training data. The training data may include any originally labeled documents as well. The documents of the training data include identifiers for one and only one category. A document for the training data may include multiple different identifiers for the associated category. A document for the training data does not contain identifiers for multiple categories. In some examples, it may be useful to flag documents with multiple identifiers for expert review. Alternately, these documents may he used as difficult test cases for assessing performance of the trained machine learning system. These documents are difficult because they contain identifiers for multiple categories and determining which category is a better fit is a more complex problem.

The unlabeled data may be medical records and the terms on the inclusion and exclusion list comprise medical terms. The medical records may be deidentified prior to use. In an example, the method includes deidentifying and/or anonymizing the unlabeled data prior to further processing.

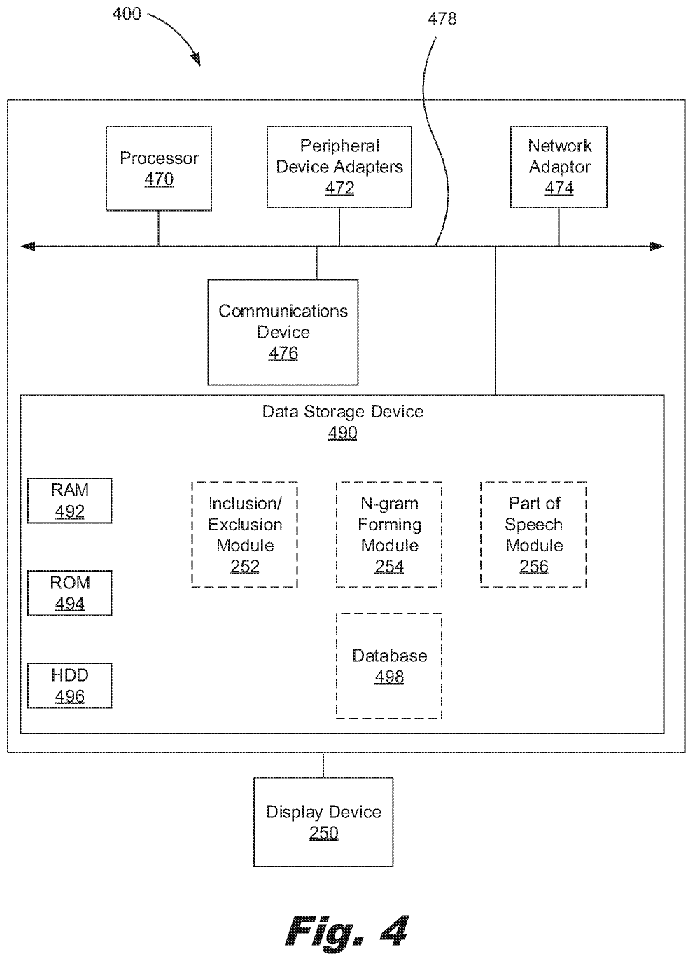

FIG. 4 is a diagram of a computing device (400) for identifying ground truth of unlabeled documents, according to an example of the principles described herein. The computing device (400) may be implemented in an electronic device. Examples of electronic devices include servers, desktop computers, laptop computers, personal digital assistants (PDAs), mobile devices, smartphones, gaming systems, and tablets, among other electronic devices.

The computing device (400) may he utilized in any data processing scenario including, stand-alone hardware, mobile applications, through a computing network, or combinations thereof. Further, the computing device (400) may be used in a computing network. In an example, the methods provided by the computing device (400) are provided as a service over a network by, for example, a third party.

To achieve its desired functionality, the computing device (400) includes various hardware components. Among these hardware components may be a number of processors (470), a number of data storage devices (490), a number of peripheral device adapters (474), and a number of network adapters (476). These hardware components may be interconnected through the use of a number of busses and/or network connections. In an example, the processor (470), data storage device (490), peripheral device adapters (474), and a network adapter (476) may be communicatively coupled via a bus (478).

The processor (470) may include the hardware architecture to retrieve executable code from the data storage device (490) and execute the executable code. The executable code may, when executed by the processor (470), cause the processor (470) to provide a summary of a previously covered topic to a user joining a meeting. The functionality of the computing device (100) is in accordance to the methods of the present specification described herein. In the course of executing code, the processor (470) may receive input from and provide output to a number of the remaining hardware units.

The data storage device (490) may store data such as executable program code that is executed by the processor (470) and/or other processing device. The data storage device (490) may specifically store computer code representing a number of applications that the processor (470) executes to implement at least the functionality described herein.

The data storage device (490) may include various types of memory modules, including volatile and nonvolatile memory. For example, the data storage device (490) of the present example includes Random Access Memory (RAM) (492), Read Only Memory (ROM) (494), and Hard Disk Drive (HDD) memory (496). Other types of memory may also be utilized, and the present specification contemplates the use of many varying type(s) of memory in the data storage device (490) as may suit particular application of the principles described herein. In certain examples, different types of memory in the data storage device (490) may be used for different data storage needs. For example, in certain examples the processor (470) may boot from Read Only Memory (ROM) (494), maintain nonvolatile storage in the Hard Disk Drive (HDD) memory (496), and execute program code stored in Random Access Memory (RAM) (492).

The data storage device (490) may include a computer readable medium, a computer readable storage medium, or a non-transitory computer readable medium, among others. For example, the data storage device (490) may be, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The data storage device (490) may include a database (498). The database (498) may include users. The database (498) may include topics. The database (498) may include records of previous post and/or documents. The database (498) may include extracted workflows for a post and/or document.

Hardware adapters, including peripheral device adapters (474) in the computing device (400) enable the processor (470) to interface with various other hardware elements, external and internal to the computing device (400). For example, the peripheral device adapters (474) may provide an interface to input/output devices, such as, for example, display device (250). The peripheral device adapters (474) may also provide access to other external devices such as an external storage device, a number of network devices such as, for example, servers, switches, and routers, client devices, other types of computing devices, and combinations thereof.

The display device (250) may be provided to allow a user of the computing device (100) to interact with and implement the functionality of the computing device (100). The peripheral device adapters (474) may also create an interface between the processor (470) and the display device (250), a printer, and/or other media output devices. The network adapter (476) may provide an interface to other computing devices within, for example, a network, thereby enabling the transmission of data between the computing device (400) and other devices located within the network.

The computing device (400) may, when executed by the processor (470), display the number of graphical user interfaces (GUIs) on the display device (250) associated with the executable program code representing the number of applications stored on the data storage device (490). The GUIs may display, for example, interactive screenshots that allow a user to interact with the computing device (400). Examples of display devices (250) include a computer screen, a laptop screen, a mobile device screen, a personal digital assistant (PDA) screen, and a tablet screen, among other display devices (250).

In an example, the database (498) stores the corpus of documents being used to generate the training set. The database (498) may include the labeled documents making up the training set.

The computing device (400) further includes a number of modules (252-256) used in the implementation of the systems and methods described herein. The various modules (252-256) within the computing device (400) include executable program code that may be executed separately. In this example, the various modules (252-256) may be stored as separate computer program products. In another example, the various modules (252-256) within the computing device (400) may be combined within a number of computer program products; each computer program product including a number of the modules (252-256). Examples of such modules include an inclusion/exclusion list generation module (252), an n-gram forming module (254), and part of speech module (254).

In FIG. 4, the dashed boxes indicate instructions (252, 254, and 256) and a database (498) stored in the data storage device (490). The solid boxes in the data storage device (490) indicate examples of different types of devices which may be used to perform the data storage device (490) functions. For example, the data storage device (472) may include any combination of RAM (492), ROM (494), HDD (496), and/or other appropriate data storage medium, with the exception of a transient signal as discussed above.

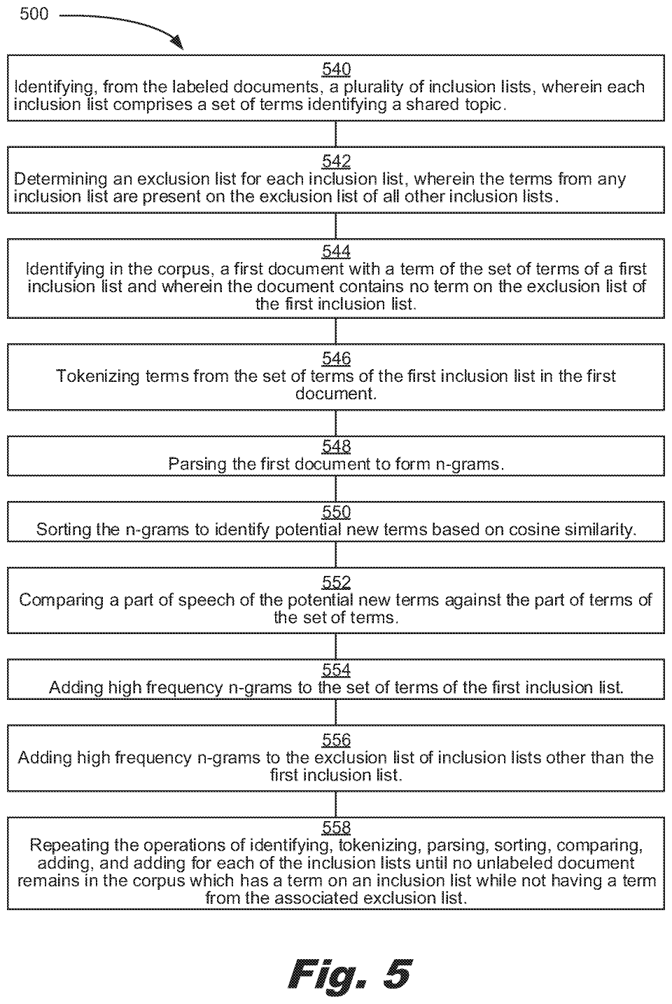

FIG. 5 shows a flowchart of a computer-implemented method (500) of topic extraction from a corpus of documents having a subset of labeled documents consistent with this specification. The method (500) including: identifying (540), from the labeled documents, a plurality of inclusion lists, wherein each inclusion list includes a set of terms identifying a shared topic; determining (542) an exclusion list for each inclusion list, wherein the terms from any inclusion list are present on the exclusion list of all other inclusion lists; identifying (544) in the corpus, a first document with a term of the set of terms of a first inclusion list and wherein the document contains no term on the exclusion list of the first inclusion list; tokenizing (546) terms from the set of terms of the first inclusion list in the first document; parsing (548) the first document to form n-grams; sorting (550) the n-grams to identify potential new terms based on cosine similarity; comparing (552) a part of speech of the potential new terms against the part of terms of the set of terms; adding (554) high frequency n-grams to the set of terms of the first inclusion list; adding (556) high frequency n-grams to the exclusion list of inclusion lists other than the first inclusion list; (558) repeating. the operations of identifying, tokenizing, parsing, sorting, comparing, adding, and adding for each of the inclusion lists until no uncategorized document remains in the corpus which has a term on an inclusion list while not having a term from the associated exclusion.

The method (500) includes identifying (540), from the labeled documents, a plurality of inclusion lists, wherein each inclusion list includes a set of terms identifying a shared topic, As discussed above, the terms of the set of terms may be extracted from a database, The terms may be the labels of the labeled documents, In an example, manual review may be conducted to determine in any labels need to be combined prior to continuing the process.

The method (500) includes determining. (542) an exclusion list for each inclusion list, wherein the terms from any inclusion list are present on the exclusion list of all other inclusion lists. The exclusion list includes all the other categories being evaluated. However, the exclusion list is not limited to these terms. Additional terms may be added to the exclusion list to provide specificity to the categorization. For Example, if the category is type 1 diabetes, then terms such as “type-2”, “type 2”, or “adult onset” may be included in the exclusion list even if type-2 diabetes is not being extracted as a different topic. Similarly, items such as “review article” and/or problematic data sources may be added to exclusion lists.

The method (500) includes identifying (544) in the corpus, a first document with a term of the set of terms of a first inclusion list and wherein the document contains no term on the exclusion list of the first inclusion list. As discussed above, excluding documents which reference multiple categories can reduce the difficulty of making a clean determination of how a given document should be labeled. If the desire is for a single, clear, correct answer for each case in the training set (to provide high accuracy) then eliminating intermediate cases, at least during initial sorting, is useful. It may be useful to assign these more complex documents to expert reviewers. It may also be useful to break such documents into sections and analyze the sections independently. For example, if a document has a section labeled lung cancer and a different section labeled thyroid cancer and these are both different topics, then breaking the document into sections may allow effective analysis without the risk of overlap and/or incorrect labeling.

The method (500) includes tokenizing (546) terms from the set of terms of the first inclusion list in the first document; parsing (548) the first document to form n-grams. Tokenizing the terms allows the terms to be considered in context. This is useful when the terms have different lengths and would produce different n-gram results if untokenized. Tokenization provides a way to combine the terms to avoid a desired n-gram from being unrecognized due to it occurring with a variety of different terms each having a lower frequency. Tokenization may also be used on other terms in the document(s). In some examples, tokenization is performed base on roots of words to avoid the variation from different tenses or similar variation from splitting a shared structure into multiple lower frequency structures. Tokens may be numbered and/or otherwise incremented. In an example, the tokenization is reversed after the n-grams are tabulated and before performing the part of speech analysis.

Tokenization may also be performed as part of anonymization. For example, the name on a medical record may be tokenized to Patient, regardless of the form of the name including full name, first name, last name, titles and modifiers (e.g., Mrs., Dr., PhD), etc. Similarly, Social Security Numbers, birth dates, and similar confidential information may be tokenized to a generic form to allow more overlap between documents and increase privacy. Such privacy tokenization may be performed prior to other parts of this method (500). Similarly, tokenization may facilitate identifying frequent n-grams. For example, Bob complains of pain will likely occur less than “patientname” complains of pain.

The method (500) includes sorting (550) the n-grams to identify potential new terms based on cosine similarity. The use of cosine similarity between the known terms and the potential new terms provides a way of assessing the commonality of use and structure for the new terms with the existing terms. This is a strong indicator that the news terms are overlapping and/or synonymous with the existing terms.

The method (500) includes comparing (552) a part of speech of the potential new terms against the part of terms of the set of terms. The use of part of speech analysis provides a useful check against accidental inclusion of related but different terms. In some examples, new terms which fail the part of speech comparison are flagged as potential new topics. This process may be automatic. This process may include manual review. The desirability of identifying new topics depends in part on the purpose of the training set and the machine learning system.

The method (500) includes adding (554) high frequency n-grams to the set of terms of the first inclusion list. Once the high frequency n-grams have passed the part of speech check, they may be added to the inclusion list for the category.

The method (500) includes adding (556) high frequency n-grams to the exclusion list of inclusion lists other than the first inclusion list. Including the new members of the inclusion list for a category on the exclusion list for other categories preserves the non-overlap between the categories. This action may exclude documents which were previously included because they now include both an identifier for a category as well as the newly added member of the exclusion list for that category. Accordingly, adding new documents to the set also further limits overlap between categories, including the relevance (quality) of the remaining documents to their identified category. A variety of additional activities may be performed with documents having terms of both an inclusion and exclusion list for a topic. Accordingly, identifying and/or flagging these documents may be useful. In one example, these excluded documents are sorted by the number of instances of category being referenced vs. all other categories being referenced. This sorting may be used with a threshold to rejoin excluded documents to the corpus, for example, by removing a portion of the document containing the less frequent term. For example, if a document contains 40 references to thyroid cancer and 1 reference to lung cancer, a portion of the document around the lung cancer reference may be removed from the document and the document rejoined to the corpus. In such cases, determining the margin around the less frequent reference(s) to be extracted may he based on the ratio between the more frequent references and less frequent references.

The method (500) includes (558) repeating the operations of identifying, tokenizing, parsing, sorting, comparing, adding, and adding for each of the inclusion lists until no uncategorized document remains in the corpus which has a term on an inclusion list while not having a term from the associated exclusion. As discussed with respect to other examples, the use of an iterative approach allows the method to reach terms beyond those with a direct relationship with the known terms initially provided. This iterative approach accordingly allows inclusion and review of more terms and more documents than would be otherwise reached.

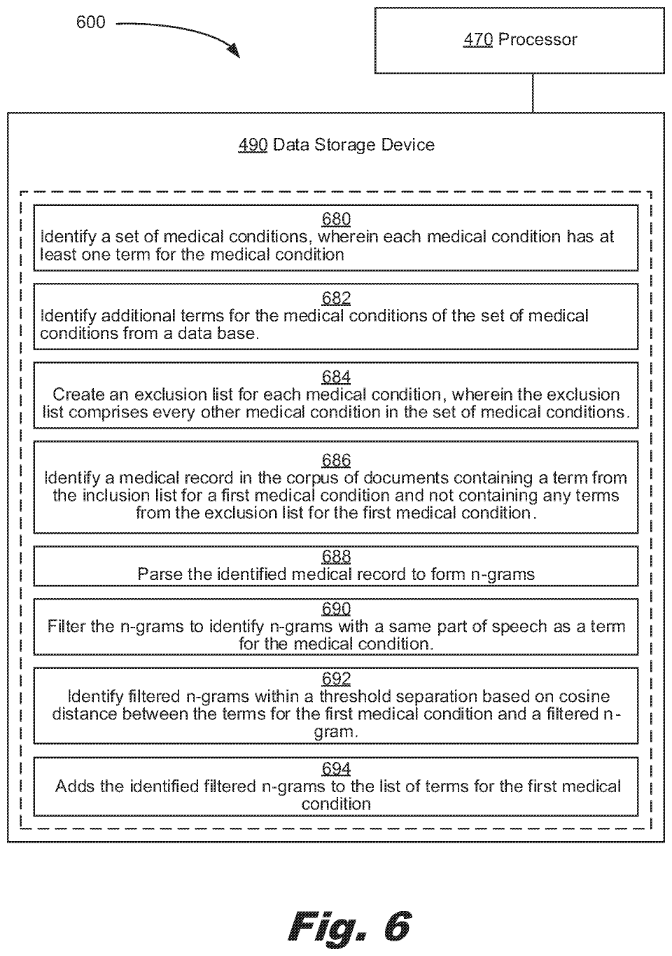

FIG. 6 shows a diagram for a system (600) for reviewing medical diagnoses in an example consistent with this specification. The system (600) includes: a corpus of medical records stored in a computer readable non-transitory format, and a processor (470) having an associated memory (672), wherein the data storage device (490) contains instructions, which, when executed, cause the processor (470) to: identify (680) a set of medical conditions, wherein each medical condition has at least one term for the medical condition; identify (682) additional terms for the medical conditions of the set of medical conditions from a data base; create (684) an exclusion list for each medical condition, wherein the exclusion list comprises every other medical condition in the set of medical conditions; identify (684) a medical record in the corpus of documents containing a term from the inclusion list for a first medical condition and not containing any terms from the exclusion list for the first medical condition; parse (686) the identified medical record to form n-grams; filter (688) the n-grams to identify n-grams with a same part of speech as a term for the medical condition; identify (690) filtered n-grams within a threshold separation based on cosine distance between the terms for the first medical condition and a filtered n-gram; and add (692) the identified filtered n-grams to the list of terms for the first medical condition.

The system (600) is a system for reviewing medical diagnosis. In some examples, the system (600) may also be able to generate medical diagnosis and/or recommend diagnosis based on a provided medical record and a machine learning component of the system.

The system (600) includes a corpus of medical records stored in a computer readable non-transitory format. The computer readable non-transitory format is not a signal per se. The corpus of medical records may be stored in an encrypted format. The corpus of medical records may be anonymized prior to storage in the format. The corpus of medical records may be anonymized once placed in the format. The processor (470) may redact the corpus of documents.

The processor (470) may be a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The data storage device (490) stores the instructions. The instructions may be stored in entirety in the data storage device (490). The instructions may be stored as needed in the data storage device (490). The data storage device (490) may provide the instructions to the processor (470) as required to perform the recited functions. The instructions as stored in a computer readable format in a computer readable storage medium.

The processor (470) identifies (680) a set of medical conditions, wherein each medical condition has at least one term for the medical condition. These terms form the inclusion list for the medical condition. The inclusion list is a list of terms which identify the medical condition.

The processor (470) identifies (682) additional terms for the medical conditions of the set of medical conditions from a data base. Extracting additional terms from a database provides a broader set of terms to work with rather than relying solely on seed terms provided by an expert or similar.

The processor (470) creates (684) an exclusion list for each medical condition, wherein the exclusion list comprises every other medical condition in the set of medical conditions. As discussed with previous examples, keeping the conditions non-overlapping and excluding documents with multiple relevant conditions provides a cleaner and higher accuracy training set. The downside is that the complex examples which include overlapping conditions are not used explicitly in this provided training set. In some examples, the medical record may be rehabilitated as discussed above. For example, if there is one reference to a first condition and 20 references to a second condition, the first may be excised from the document or other sections/portions of the document used. If the ratio of references is strongly disproportionate, it suggests that the minor category is not being mentioned in the context of the medical record describing that condition.

The processor (470) identifies (686) a medical record in the corpus of documents containing a term from the inclusion list for a first medical condition and not containing any terms from the exclusion list for the first medical condition. Medical which reference multiple medical conditions may be reserved for other uses, including as challenge cases to the machine learning system. It is useful to not over identify the conditions being evaluated as this will eliminate those records where a patient has other conditions operating as cofactors. For example, it may be useful not to include congestive heart failure or diabetes as conditions when assessing cancer records.

The processor (470) parses (688) the identified medical record to form n-grams. The n-grams may include skip n-grams. The n-grams may be only skip n-grams. The size of the n-grams may be limited to a fixed number of words. The n-grams may require a threshold of occurrences, such as 5 or 3, to avoid sweeping in too broadly once the average counts for the n-grams drops to near 1.

The processor (470) filters (690) the n-grams to identify n-grams with a same part of speech as a term for the medical condition. The n-grams may be evaluated for their part of speech in context to facilitate identification of the part of speech. This also produces other artifacts including a parsed document with all the pails of speech identified which may be useful for other purposes including authorship verification, natural language processing, etc.

The processor (470) identifies (692) filtered n-grams within a threshold separation based on cosine distance between the terms for the first medical condition and a filtered n-gram. The use of cosine distance allows effective comparison of the pattern of use of the filtered n-grams with the known identifiers. This approach allows the system (600) to match filtered n-grams (synonyms) and/or related conditions based on the text patterns and use associated with the control terms.

The processor (470) adds (694) the identified filtered n-grams to the list of terms for the first medical condition. The processor (470) may repeat a portion of the process using the additional information provided by the identified filtered n-grams. The use of an iterative approach can allow additional extension of the categories to new terms. The use of an iterative approach can also refine the quality of the labeled references to serve as a training set for a machine learning system. In an example, the processor (470) further identifies a training set containing medical records with a single identified medical condition where the medical condition is the ground truth for that medical record. The processor (470) may further provide the training set to train a machine learning system. In an example, a fraction of the records of the training set are reserved as test cases rather than training cases.

It will be appreciated that, within the principles described by this specification, a vast number of variations exist. It should also be appreciated that the examples described are only examples, and are not intended to limit the scope, applicability, or construction of the claims in any way.

What is claimed is:

1. A computer readable storage medium comprising instruction which when executed cause a processor to: generate a machine learning model based on a limited set of labeled training data and a larger set of unlabeled training data, the labeled and unlabeled training data having a common subject matter, by:
for each of a number of categories, identifying an inclusion list of terms corresponding to training data being classified and an exclusion list of terms corresponding to training data not currently being classified;
for each of the categories, taking a subset of documents from the unlabeled training data, the subset including all documents that contain any term from the inclusion list and excluding any document that contain a term from the exclusion list;
within each subset of documents, identifying terms that are similar within a set standard to a term from the inclusion list or exclusion list and adding those identified terms to the inclusion list or exclusion list, respectively;
repeating the taking of a subset of documents from the unlabeled training data based on the inclusion and exclusion lists and the identification of similar terms from within those subsets of documents until no new similar terms are identifies within the set standard; and
generating training data of the machine learning model comprising a final subset of documents for each category from the unlabeled training data.

2. The medium of claim 1, wherein the set standard comprises cosine similarity of corresponding word or phrase vectors.

3. The medium of claim 1, further comprising, when generating the inclusion list and exclusion list, extracting potential phrases from the unlabeled training data and tokenizing each of the phrases as a single word.

4. The medium of claim 3, further comprising generating word vectors for each document of the subset based on the tokenized phrases.

5. The medium of claim 1, wherein the unlabeled data comprises medical records and the terms on the inclusion and exclusion list comprise medical terms.

6. A computer-implemented method of topic extraction from a corpus of documents having a subset of labeled documents, the method comprising:
identifying, from the labeled documents, a plurality of inclusion lists, wherein each inclusion list comprises a set of terms identifying a shared topic;
determining an exclusion list for each inclusion list, wherein the terms from any inclusion list are present on the exclusion list of all other inclusion lists;
identifying in the corpus, a first document with a term of the set of terms of a first inclusion list and wherein the document contains no term on the exclusion list of the first inclusion list;
tokenizing terms from the set of terms of the first inclusion list in the first document;
parsing the first document to form n-grams;
sorting the n-grams to identify potential new terms based on cosine similarity;
comparing a part of speech of the potential new terms against the part of terms of the set of terms;
adding high frequency n-grams to the set of terms of the first inclusion list;
adding high frequency n-grams to the exclusion list of inclusion lists other than the first inclusion list;
repeating the operations of identifying, tokenizing, parsing, sorting, comparing, adding, and adding for each of the inclusion lists until no unlabeled document remains in the corpus which has a term on an inclusion list while not having a term from the associated exclusion list.

7. The method of claim 6, wherein a document is a paragraph of a larger document.

8. The method of claim 6, wherein the exclusion list is further populated with identified terms from labeled documents in the corpus.

9. The method of claim 6, wherein all documents in the corpus having the identified keyword without a keyword from the associated exclusion list are parsed to form n-grams and wherein the n-grams are sorted together to identify high frequency n-grams.

10. The method of claim 6, wherein the n-grams are sorted based on frequency over baseline, wherein the baseline is determined from a second corpus of documents without terms from any exclusion list.

11. The method of claim 6, further comprising identifying a high frequency n-gram associated with a new topic and creating a new topic including the high frequency n-gram on the inclusion list.

12. The method of claim 6, further comprising extracting topics from a database.

13. The method of claim 6, wherein the documents of the corpus are abstracts.

14. A system for reviewing medical diagnoses, the system comprising:
a corpus of medical records stored in a computer readable non-transitory format, and
processor having an associated memory, wherein the associated memory contains instructions, which, when executed, cause the processor to:
identify a set of medical conditions, wherein each medical condition has at least one term for the medical condition;
identify additional terms for the medical conditions of the set of medical conditions from a data base;
create an exclusion list for each medical condition, wherein the exclusion list comprises every other medical condition in the set of medical conditions;
identify a medical record in the corpus of documents containing a term from the inclusion list for a first medical condition and not containing any terms from the exclusion list for the first medical condition;
parse the identified medical record to form n-grams;
filter the n-grams to identify a-grams with a same part of speech as a term for the medical condition;
identify filtered n-grams within a threshold separation based on cosine distance between the terms for the first medical condition and a filtered n-gram; and
add the identified filtered n-grams to the list of terms for the first medical condition.

15. The system of claim 14, wherein the instructions further cause the processor to redact the corpus of documents.
